(19) United States
(12) Patent Application Publication
(10) Pub. No.: US 2026/0246851 A1
(43) Pub. Date: Aug. 20, 2026

(54) CLASSIFICATION AND FUNCTIONALITY OF IOT DEVICES

(71) Applicant: IOTIC LABS LIMITED, London (GB)

(72) Inventors: Paul Nigel Green, London (GB); Mark Nicholas James Wharton, London (GB)

(21) Appl. No.: 18/869,782

(22) PCT Filed: May 26, 2023
(86) PCT No.: PCT/EP2023/064256

§ 371 Date: Nov. 26, 2024

(30) Foreign Application Priority Data
May 31, 2022 (GB) 2208049.3

(51) Int. Cl. H04L 67/562; G06F 18/2113; G06F 123/02

(52) U.S. Cl. CPC H04L 67/562; G06F 18/2113; G06F 2123/02

(57) ABSTRACT

A method of dynamically classifying a data source in a connection brokerage system is described. The method comprises receiving data from the data source; determining, based on the data, a class ID for the data source; and updating a registry entry for a virtual asset registered in a connection brokerage system to store the determined class ID for the data source.

### BACKGROUND

The Internet of Things (IoT) refers to uniquely identifiable objects in an internet-like structure where the objects are data-enabled and may comprise data sources (e.g. they may be capable of reporting data on a regular, event-triggered or on-demand basis) and/or actuators (e.g. they may be capable of receiving a control instruction and taking an action in response to the control instruction). Equipping all objects in the world with minuscule identifying devices or machine-readable identifiers could transform daily life. For instance, it may improve the growth of plants in a greenhouse by enabling collection of multiple data sources (e.g. air quality inside the greenhouse, weather outside the greenhouse, soil temperature, etc.) and control of watering systems based on the sensed data. However there are a large number of practical challenges in the implementation of IoT. These challenges include aspects relating to security of the network, the devices and the data streams and aspects relating to authentication and trust between devices (e.g. a device that provides data and a device that consumes that data). As the number of IoT devices increases, the challenges in relation to device discovery and interconnection become more complex.

The embodiments described below are not limited to implementations which solve any or all of the disadvantages of known systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein are methods of dynamically classifying a data source and methods of dynamically provisioning functionality to a data source. These methods may be used together or independently. The methods described herein enable a data source to be deployed and then subsequently classified (e.g. if its classification is not known at the time of deployment) and/or enable the classification of a data source to be changed/updated at any time. Similarly, the methods described herein enable the functionality of data source to be changed/updated/enhanced automatically (i.e. without user involvement). The methods described herein result in a more flexible and adaptable system.

A first aspect provides a method of dynamically classifying a data source in a connection brokerage system, the method comprising: receiving event data from the data source; determining, based on the event data, a class ID for the data source; and updating a registry entry for a virtual asset registered in a connection brokerage system to store the determined class ID for the data source.

A second aspect provides a method of dynamically provisioning functionality associated with a virtual asset registered in a connection brokerage system, the method comprising: receiving data from a data source having a class ID stored in a registry entry for the virtual asset; determining, using the data and the class ID, one or more functions provided by the data source based on the determined contextual metadata for the data source; and updating the registry entry for the virtual asset with service descriptors associating the determined one or more functions with the data source, wherein the service descriptors allow the virtual asset to offer access to the one or more functions as a service within the connection brokerage system.

A third aspect provides a system configured to perform any of the methods described herein.

A fourth aspect provides computer program code which, when executed by a processor, causes the processor to perform any of the methods described herein.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a flow diagram of an example method of dynamically classifying a data source that may be implemented in a connection brokerage system;

FIG. 2 is a flow diagram of an example method of determining a class ID;

FIGS. 3A, 3B, 3C and 3D show four different example scenarios for the implementation of the method of FIG. 1;

FIG. 4 is a flow diagram of a first example method of dynamically assigning functionality to a virtual asset;

FIG. 5 is a flow diagram of a first example method of determining a service descriptor;

FIG. 6 is a flow diagram of a second example method of determining a service descriptor;

FIG. 7 is a flow diagram of a second example method of dynamically assigning functionality to a virtual asset;

FIG. 8 is a flow diagram of a third example method of determining a service descriptor;

FIG. 9 is a flow diagram of another example method of determining a class ID; and FIG. 10 is a schematic diagram of a computing device that may run an agent of a virtual asset.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

As described above, there are a large number of practical challenges in the implementation of IoT. As well as problems relating to security, authentication and trust (e.g. where the ownership of different data sources and/or actuators is diverse and/or there are security/safety concerns regarding the data or the actuator control), configuring and managing the large number of deployed devices is difficult, particularly as a consequence of the scale (i.e. the potential number of IoT devices that may be deployed). Furthermore, whilst some IoT devices may only provide data (e.g. measurement data or other locally generated data), others may include actuators, or control functionality for connected actuators. This means that there is a huge range of capabilities of the deployed devices (e.g. in terms of generating data and/or receiving controls for local actuators).

In order for an IoT device to serve a useful purpose, other devices need to be able to find the IoT device and then receive data from the IoT device and/or transmit control data to the IoT device. A connection brokerage system may be used to broker such connections and in order to broker connections, the connection brokerage system comprises a registrar functionality (which may be implemented as a centralized entity or in a distributed manner) and a plurality of virtual assets. A virtual asset acts as a proxy for a real device (e.g. a physical device such as an IoT device that generates data using one or more sensors), a data source (e.g. where the data is not measurement/sensor data), another virtual asset or a group of real devices and/or other virtual assets. Each virtual asset comprises metadata that describes what it is a proxy for (e.g. the real device, data source, group of devices, etc.) along with information about data streams that can be provided by the virtual asset (e.g. wind speed in m/s) and/or can be received by the virtual asset (e.g. on/off or other control signals). Each virtual asset therefore corresponds to a data entry in the connection brokerage system, referred to as a registry entry, that is created when the virtual asset is created. There is a separate agent that corresponds to a virtual asset which drives (or encodes) the behaviour of the virtual asset. The code resides outside the connection brokerage system and may run anywhere (e.g. on a cloud-based server, on the real device itself, or any other computing device located outside the connection brokerage system) as long as it can connect to the virtual asset (i.e. to the data stored in the registry entry for the virtual asset in the connection brokerage system). In this way, the data and code relating to a virtual asset are separate. The agent may act as a bridge between a virtual asset and its corresponding real device (i.e. between the virtual asset and the physical electronics in the device) and may operate to report the state of the real device to the virtual asset and/or to provide a hardware interface to the real device, if the real device is controllable externally (e.g. it comprises or is connected to an actuator). In various examples, there may be an agent that acts as a bridge between each virtual asset and its corresponding real device, although some agents may act as a bridge for more than one virtual asset and/or real device (e.g. there may be fewer agents than virtual assets and/or real devices).

An IoT device registers with the connection brokerage system in order that it can distribute data it generates or in order that it can receive controls for local actuators and on registration, a corresponding virtual asset, and hence registry entry, is created. Such a virtual asset may be referred to as a service providing virtual asset (SP-VA). A device that wishes to obtain data from the system also registers with the connection brokerage system and on registration, a corresponding virtual asset, and hence registry entry, is created. Such a virtual asset may be referred to as a service requesting virtual asset (SR-VA). A physical device may both provide services and request services (i.e. request data and provide control signals) and so may have two (or more) associated virtual assets. In such examples there may be a single agent that acts as a bridge for all the virtual assets associated with a single real device or there may be more than one agent.

A registrar functionality within the connection brokerage system, which may be implemented as a central server or in a distributed manner, manages the registration of real devices (including identity management), creation of virtual assets and storing and maintaining (e.g. updating when required) metadata about each of the virtual assets in the system. Example registration sequences are shown and described in the following PCT applications WO2015/052478, WO2015/052479, WO2015/052480, WO2015/052481, WO2015/052482, WO2015/052483 and WO2015/052512 and registration may involve authentication of the real device and creation of the counterpart virtual asset.

The registrar functionality also brokering connections between virtual assets (including identity management and global search functionality), i.e. the registrar functionality brokers connections between service requesting virtual assets and service providing virtual assets that are already registered in the system. When a connection is brokered between a service requesting virtual asset and a service providing virtual asset, the service requesting virtual asset subscribes to a data feed or control stream of the service providing virtual asset and dependent upon the nature of the subscription either receives the data stream (i.e. the service requesting virtual asset, or its counterpart real device, receives the data stream from the service providing virtual asset or its counterpart real device) or is enabled to provide control signals (i.e. the service requesting virtual asset, or its counterpart real device, can send control signals to the service providing virtual asset or its counterpart real device). Example methods of brokering connections between virtual assets are shown and described in the referenced PCT applications. Once a connection has been brokered by the registrar functionality, the data (e.g. measurement data or control signals) may be transferred without further involvement of the registrar functionality (i.e. any data transfer does not go via the registrar functionality).

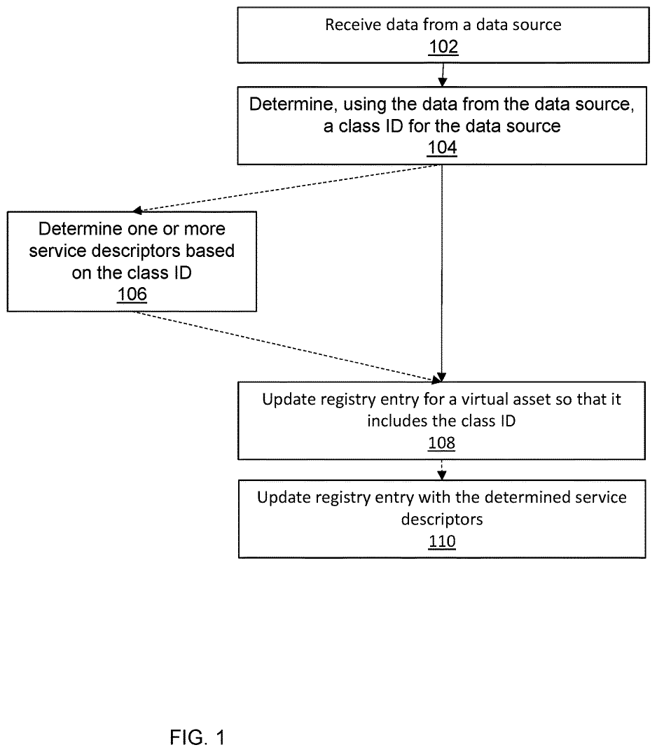

FIG. 1 shows flow diagram of an example method of dynamically classifying a data source that may be implemented in a connection brokerage system. As described above the connection brokerage system comprises a plurality of virtual assets and a registrar functionality that brokers connections between virtual assets. The registrar functionality may additionally perform other functions as described above. The data source may be a real device (e.g. an IoT device comprising a sensor) or any other data source (e.g. where the data is not measurement/sensor data).

The method of FIG. 1 may, for example, be used to determine the nature and/or properties of a real device (e.g. an IoT device) that is not self-aware (i.e. a real device that does not know what it is) when it switches on for the very first time and has not yet been classified in any way within the connection brokerage system. This simplifies the deployment of IoT devices and makes IoT systems more scalable because it is not necessary to configure each device when manufactured or upon deployment. Where an IoT device is suitable for use in many different applications, use of the method of FIG. 1 avoids the need to fix the end use of the device, thereby reducing the complexity of manufacture and deployment.

The method of FIG. 1 may in addition, or instead, be used to re-classify a real device that is not self-aware at a later point during its operation, e.g. after having been updated or reset or after a prolonged switch off, either to confirm an existing classification or to enhance or update the properties of a real device over its lifetime. The method of FIG. 1 may also be used to enrich the data stream output by the data source (where, as detailed above, the data source may be a real device or any other data source, including a virtual data source such as generated by a virtual asset).

As shown in FIG. 1, the method comprises receiving data from a data source (block 102) and then using this data to determine a class identifier (class ID) for the data source (block 104). In various examples, this data that is received from a data source may be referred to as ‘event data’ or time series data (e.g. a series of data points, which may be time stamped, that occur over a period of time). As described above, the data that is received from a data source may be transmitted by the data source on a regular, event-triggered or on-demand basis. The registry entry for a virtual asset is then updated to include the class ID (block 108). Where the data source is a real device, the registry entry that is updated (in block 108) may be the registry entry for a counterpart virtual asset or a registry entry of a newly created virtual asset, as described in more detail below. Where the data source is a virtual asset (which may be referred to as a synthesizing entity as it generates a new data stream from data received by the virtual asset), the registry entry that is updated (in block 108) may be the registry entry of the data source or a registry entry of a newly created virtual asset, as described in more detail below. As a consequence of the update to the registry entry (in block 108), new connections may be brokered with the virtual asset based on the updated class ID (e.g. as a result of a service requesting virtual asset looking for a service providing virtual asset with the particular class ID).

The data source from which data is received (in block 102) may, for example, be an object, a sensor, a machine part, and actuatable machine part or a device. As noted above, the data source may alternatively be a virtual asset (e.g. a synthesizing entity).

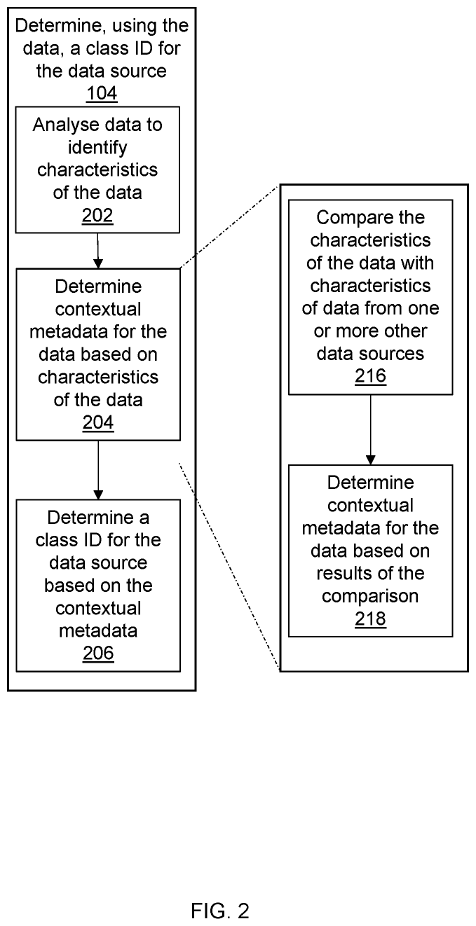

The determining of the class ID (in block 104) may involve a number of different stages and, as shown in FIG. 2, it may comprise first analysing the data to identify characteristics of the data (block 202) and then, based on the determined characteristics, determining contextual metadata for the received data (block 204). The contextual metadata is then used to determine a class identifier (class ID) for the data source (block 206).

The characteristics of the data that are identified (in block 202) and then used to determine the contextual metadata (in block 204) may comprise one or more of: the location of the data source (e.g. if included in the data), the data values or ranges of the data values (e.g. values are always in a range 0-100° C.), the format of the digital data and the data time signature (e.g. the times when data is generated or the times when there are changes in the data such as a step change in data value or a data value crossing a threshold). The data time signature may define one or more patterns in the data.

The determination of the contextual metadata (in block 204) may involve a comparison of the characteristics of the data (which may be referred to as ‘data signatures’) with characteristics of data streams from other data sources which have already been classified (block 216). Having extracted, or otherwise determined, the characteristics of the data (block 202), the comparison (in block 216) may involve comparing data signatures to look for correlations between data, e.g. to identify one or more known data sources with the same or similar characteristics, where the term ‘known data source’ is used to refer to a data source which has already been classified and hence already has a class ID stored in its registry entry. The comparison may, for example, identify data sources with matching data time signatures (i.e. where events of the same nature/type happen at approximately the same time), data sources with matching but offset data time signatures (e.g. where the pattern or periodicity of data time signatures is substantially the same but the actual times of detected events or changes in the data are time shifted, for example by substantially the same amount for each event), data sources with similar data time signatures (e.g. where the pattern or periodicity of data time signatures is substantially the same but the amplitudes of the signals are larger or smaller), data sources with complementary data time signatures (e.g. where the events or other changes happen at substantially the same time but the nature/type of the event/change is different), or any combination thereof.

In an example, a garden sprinkler and a moisture/water/rain detector may have complementary data time signatures if they are located proximate to each other. The data time signature of the sprinkler may define times at which the data source (i.e. the sprinkler) switches on and off. The detector's data time signature may define times at which the sensor signal is high (i.e. presence of moisture detected) or low (i.e. no moisture detected). The nature of the events are different but their timing will be synchronized if the water ejected by the garden sprinkler falls on the detector. In another example, a water tap/valve and a flow detector in a pipe to or from the tap/valve may have complementary data time signatures and depending upon the physical arrangement, the data time signatures may also be offset (e.g. where the detector is located in a pipe into which water flows when the tap is on). The data time signature of the tap/valve may define times at which the data source (i.e. the tap/valve) switches on and off. The detector's data time signature may define times at which the sensor signal is high (i.e. flow of water is detected) or low (i.e. no flow detected). The nature of the events are different but their timing will have the same periodicity but may be offset in time.

In the examples above one data stream originates from a sensor device and the matching (i.e. complementary) data stream originates from an actuator device. In other examples the matching devices may both be sensor devices (e.g. two sensors detecting the same or related phenomenon, such as a water flow sensor in a central heating system and a temperature sensor in a room heated by the central heating system).

Having identified one or more known data sources based on the comparison (in block 216), contextual metadata for the data source being classified is determined based on the nature of any match identified by the comparison and the metadata (which may include the class ID) of the matching known data source (block 218). Where an exact match is identified, the contextual metadata may be determined to be the same as the metadata of the matching known data source (e.g. it may comprise the class ID of the matching known data source) and/or identify the matching known data source. Where a time-shifted match is identified, the contextual metadata may be determined to be the same as the metadata of the matching known data source (e.g. it may comprise the class ID of the matching known data source) and/or identify the matching known data source, although in some examples there may be additional metadata included to identify the time offset. Where a complementary match is identified, the contextual metadata may include some of the metadata of the complementary known data source (e.g. it may comprise the class ID of the matching known data source) and/or identify the matching known data source, with additional metadata to indicate the identified complementary nature of the relationship between the two data sources.

In a first example, the analysis (in block 202) may identify an data time signature (e.g. a sequence or pattern of event times) from the data stream. This data time signature may define that the data goes from low to high at times X1, X2, X3, . . . Then the comparison (in block 216) may identify a known data source where the data time signature comprises the same sequence of events at the same time intervals, but that the pattern of events for the two data sources (the data source that is being analysed and may be referred to as the ‘unknown’ data source and the known data source) but the two patterns start at times which are offset, i.e. the data time signature of the known data source may define that the data goes from low to high at times X1+A, X2+A, X3+A, . . .

In a second example, the analysis (in block 202) may identify an data time signature (e.g. a sequence or pattern of event times) from the data stream. This data time signature may define that the data goes from low to high at times X1, X2, X3, . . . Then the comparison (in block 216) may identify a known data source where the data time signature comprises the same sequence of event times, but the events correspond to the data going from high to low, i.e. the data time signature of the known data source may define that the data goes from high to low at times X1+A, X2+A, X3+A, . . . (where A may be zero or may be non-zero). This may be referred to as an ‘inverse correlation’ and is an example of a ‘complementary match’.

It will be appreciated that the comparison of data streams (in block 216) may involve more complex techniques for pattern matching of data data signatures which are based on both the time sequence of the events in the data stream and the nature of those events. In various examples, a candidate set of comparison data streams may be identified based on one or more characteristics (as identified in block 202), such as the type or location of the data source and then the comparison may be performed (in block 216) between the data for the data source and the data for the comparison data streams.

In the examples described above a pairwise comparison may be performed between data time signatures for different data sources. In other examples, a candidate data time signature (i.e. the data time signature from the data source which is being classified) may be compared to aggregated data time signatures from a number of data sources, e.g. a cohort of data sources, such as all river level sensors on a particular river or all light level sensors in a particular geographic location, etc.

In addition to, or instead of, using a comparison with data characteristics of other, known, data sources, the determination of the contextual data (in block 204) may use other analysis techniques to generate the contextual data. For example, the contextual metadata may be determined based on temporal analysis of the data and/or trends in the sensor data values in the data (as determined in block 202). For example, the times when particular events occur, or the periodicity of events, may be used to determine contextual metadata. For example, such analysis (in block 202) may identify that the data peaks twice a day, approximately 12.5 hours apart, such that the peaks shift gradually later each day and based on this, and potentially other contextual data (such as the existing class ID of the data source, or location information), it may be determined that the data corresponds to tidal information and this information may be included within the contextual metadata (in block 204).

Having determined the contextual metadata (in block 204), this contextual metadata is then used to determine the class ID (in block 206). This determination may involve extracting the class ID from the contextual metadata and determining, based on the nature of the comparison result (as detailed in the contextual metadata) whether to select the same class ID or a different class ID (e.g. a class ID derived based on the class ID of the known data source and the nature of the comparison result). Referring back to the water sensor garden sprinkler example, if the known data source is the water sensor and the match is determined to be complementary, the unknown data source may be given a class ID corresponding to a water source. Where the contextual metadata does not comprise a class ID, but instead comprises data identifying a known data source and the nature of the match, the determination of the class ID (in block 206) may be determined based on this data and may, for example, involve looking up the class ID of the known data source using the contextual metadata.

The class ID that is determined (in block 206) may define what the data source (i.e. the real device) is and/or what the data stream represents. For example, the class ID may define that the data source is a particular type of device (e.g. a thermostatic value, a water level sensor, etc.) and/or that the data stream comprises a particular type of data (e.g. water levels, temperatures, etc.). In some examples, a registry entry for a virtual asset may only contain a single class ID and in such examples, the updating of the registry entry (in block 108) may comprise generating a new registry entry (and hence a new virtual asset) if an existing registry entry for the counterpart virtual asset already contains a class ID. In other examples, however, a registry entry may contain more than one class ID. In examples where a new virtual asset is created and the data source is a real device, the new virtual asset may be a second counterpart virtual asset to the real device.

In another example the data source may be a sound level sensor located close to railway tracks and it may or may not already have a class ID identifying it as a sound level sensor. Using the method of FIG. 1, a correlation may be found between the data signature from the sound level sensor and data signatures from a proximate level crossing or railway station (e.g. train arrival events at the crossing/station may always occur a defined time period before or after a high volume event at the sound level sensor). From this offset match it may be inferred that the sound level sensor is detecting the presence of a train and the sensor may be allocated a class ID to indicate that it indicates the presence of a train. In this way the method of FIG. 1 may be used to assign meaning to data streams which is far removed from the nature of the phenomenon being sensed and which may be very different from the original purpose for which the sensor was deployed.

The method of FIG. 1 may be implemented by the agent corresponding to the virtual asset which is a counterpart to the data source (where the data source is a real device), by the agent corresponding to another virtual asset in the system (irrespective of whether the data source is a real device or a virtual asset) or by a real device which is the counterpart to another virtual asset in the system (irrespective of whether the data source is a real device or a virtual asset). Where the method is implemented by an agent corresponding to a virtual asset, the agent that implements the method of FIG. 1 is stored and executed on any computing device outside the connection brokerage system.

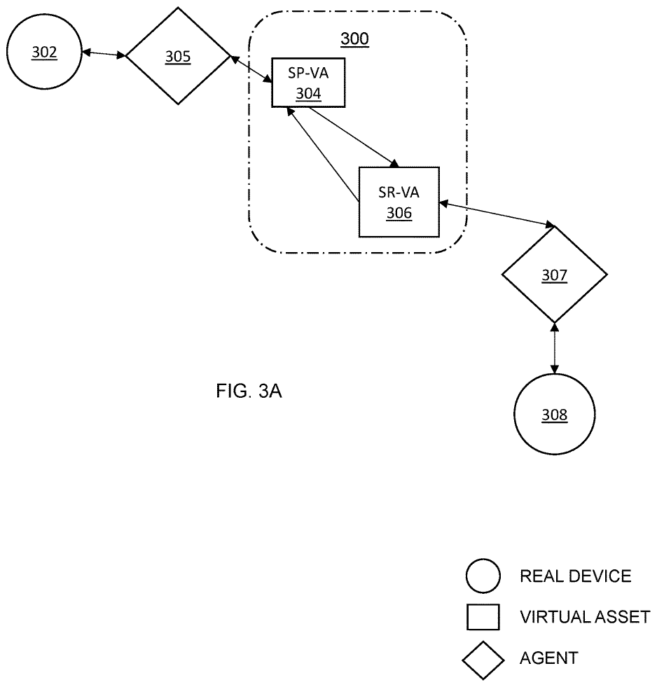

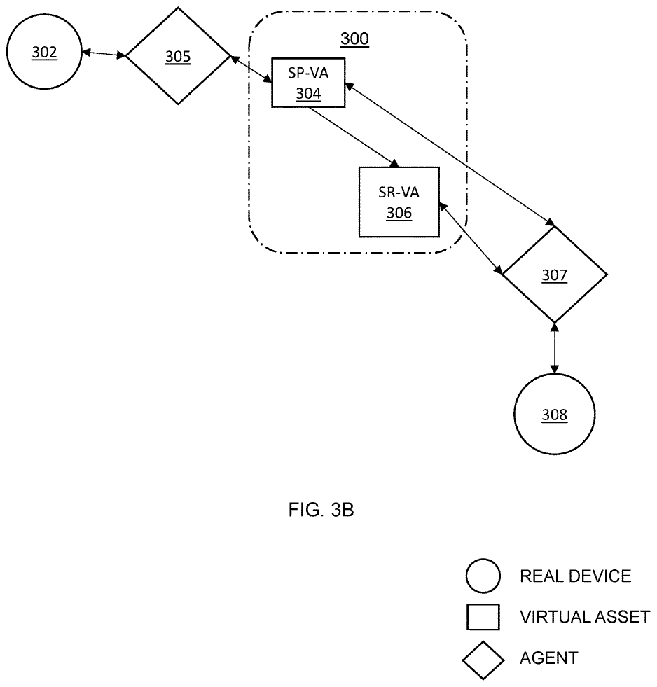

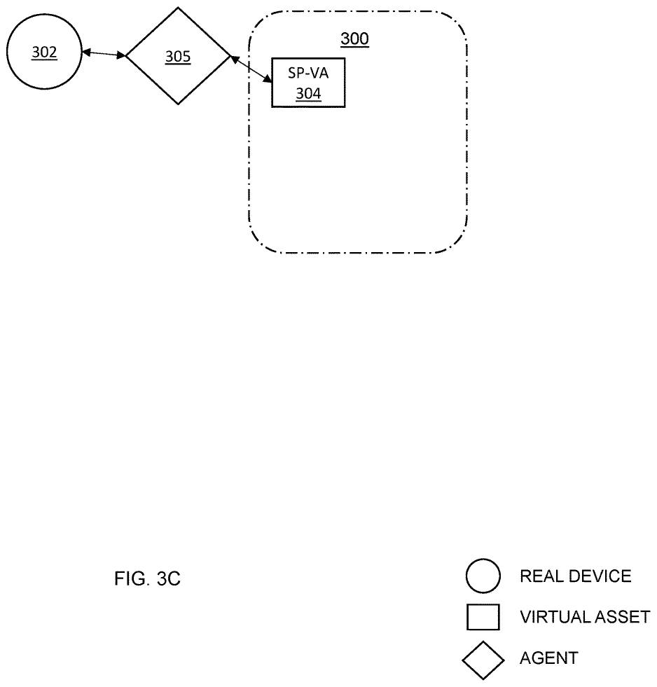

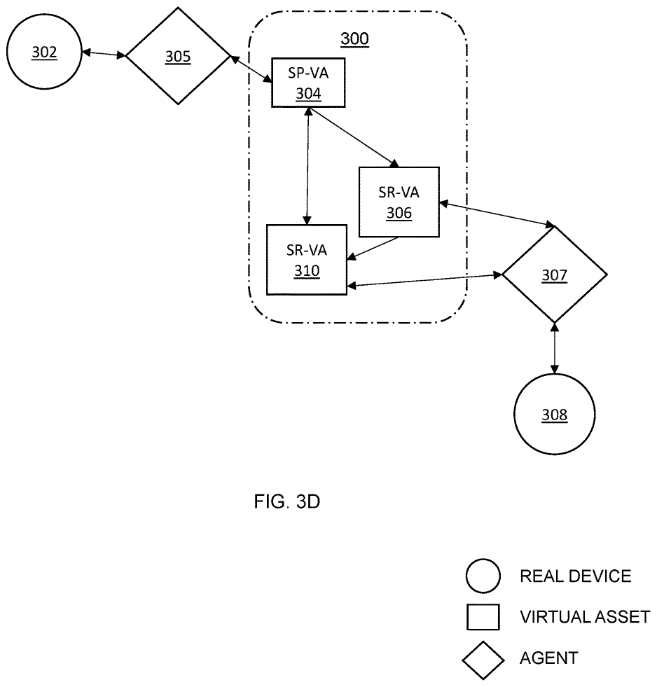

Four example scenarios for the implementation of the method of FIG. 1, and in particular the updating of the registry entry (in block 108) can be described with reference to FIGS. 3A-3D.

FIG. 3A shows the connection brokerage system 300, the data source (a real device) 302 that generates the data, the counterpart virtual asset 304 to the data source and its agent 305. The agent 305 acts as a bridge between the data source 302 and its counterpart virtual asset 304. The data is received by its counterpart virtual asset 304 via the agent 305. A second virtual asset 306 which has already brokered a connection with the first virtual asset 304 receives the data stream. This second virtual asset 306 may have a counterpart real device 308 and where there is a counterpart real device, the agent 307 of the second virtual asset 306 acts as a bridge between the second virtual asset 306 and its counterpart real device 308. The agent 307 of the second virtual asset 306, or its counterpart real device 308, implements the method of FIG. 1 and identifies a class ID for the data source 302. This class ID may identify the type of real device (e.g. a tidal sensor) or the type of the data stream (e.g. tidal data). In some examples, there may not be a 1:1 correlation between the type of a real device and the type of the data stream because the same data stream may be generated by different types of real device and/or the same data set may be interpreted in different ways (e.g. a data stream from a water level sensor may be interpreted as tidal data or water level data, and these two data types have very different signatures). In this example, the second virtual asset 306 has subscribed not only to receive the data stream but also to a “receive control in” service of the first virtual asset 302 (which may mean that two separate connections have been brokered), and so the updating step of the method of FIG. 1 comprises the second virtual asset 306 providing the class ID to the first virtual asset 304 to trigger the agent 305 of the first virtual asset 304 to update the registry entry for the first virtual asset 304.

Like FIG. 3A, FIG. 3B shows the connection brokerage system 300, the data source (a real device) 302 that generates the data, its counterpart virtual asset 304 (also referred to as the first virtual asset) and corresponding agent 305 and a second virtual asset 306 and corresponding agent 307. As noted above, the second virtual asset 306 may have a counterpart real device 308. In the scenario of FIG. 3B, the second virtual asset 306 (and, where there is one, its counterpart real device 308) belong to the owner (e.g. manufacturer) of the data source 302, so that the two virtual assets 304, 306 are related. This relationship between the first and second virtual assets 304, 306 means that the agent 307 of the second virtual asset 306 has the ability to update the registry entry for the first virtual asset 304, i.e. agent 307 has delegation of control for the first virtual asset 304. This delegation of control which enables the agent 307 of the second virtual asset 306 to update the registry entry for the first virtual asset 304 may be permanent or may be temporary (e.g. the delegation may cease once the registry entry is updated in order to increase the security of the system). The data is received from the data source 302 by its counterpart virtual asset 304 via its agent 305. A second virtual asset 306 which has already brokered a connection with the first virtual asset receives the data stream. The agent 307 of the second virtual asset 306, or its counterpart real device 308, implements the method of FIG. 1 and identifies a class ID for the data source 302. In this example, the updating step of the method of FIG. 1 comprises the agent 307 of the second virtual asset 306 updating the registry entry of the first virtual asset to include the determined class ID.

Like FIGS. 3A and 3B, FIG. 3C shows the connection brokerage system 300, the data source (a real device) 302 that generates the data and its counterpart virtual asset 304 (also referred to as the first virtual asset) and corresponding agent 305. In this third example scenario, the method of FIG. 1 is implemented by the agent 305 of the counterpart virtual asset 304, rather than by the agent of another virtual asset or real device in the system. The data from the data source 302 is received by its counterpart virtual asset 304 via its agent 305. The agent 305 of the counterpart virtual asset 304 implements the method of FIG. 1 and identifies a class ID for the data source 302 and updates its own registry entry to store the class ID.

Like FIGS. 3A-3C, FIG. 3D shows the connection brokerage system 300, the data source (a real device) 302 that generates the data, its counterpart virtual asset 304 (also referred to as the first virtual asset) and corresponding agent 305 and a second virtual asset 306 and corresponding agent 307. As noted above, the second virtual asset 306 may have a counterpart real device 308. In this scenario, the two virtual assets 304, 306 are unrelated (like in FIG. 3A), however in this example, either the first virtual asset does not advertise a ‘control in’ that enables the agent 307 of the second virtual asset to provide the class ID to the first virtual asset or the second virtual asset has not brokered the required connection to be able to provide that data to the first virtual asset. As before, the data is received from the data source 302 by its counterpart virtual asset 304 via its agent 305. A second virtual asset 306 which has already brokered a connection with the first virtual asset receives the data stream. The agent 307 of the second virtual asset 306, or its counterpart real device 308, implements the method of FIG. 1 and identifies a class ID for the data source 302. In this example, the updating step of the method of FIG. 1 comprises the creation of a new registry entry including the determined class ID and hence the creation of a new virtual asset 310 and the forwarding of the received data stream from the second virtual asset 306 to the newly created virtual asset 310. In the example shown, the agent 307 of the second virtual asset 306 is also the agent for the newly created virtual asset 310; however in another example the agent 307 may create a new agent for the newly created virtual asset 310 and then cancel its delegation of control of the newly created virtual asset 310, such that the newly created virtual asset 310 subsequently operates independently of the agent 307 of the second virtual asset 306. Having been created, the newly created virtual asset 310 may then broker a connection with the first virtual asset so that it can obtain the data stream directly from the first virtual asset 306, rather than receiving it via the second virtual asset 306. The newly created virtual asset 310 will be identified in different searches by the registrar function when brokering connections as a consequence of the different class ID.

In the example of FIG. 3D, the newly created virtual asset 310 acts as a shadow virtual asset for the first virtual asset 304. Where the real device 302 has no identity information, and so the first virtual asset 304 has no class ID, the method shown in FIG. 3D does not provide that information to the first virtual asset 304 which instead remains unidentified.

As described above, the method of FIG. 1 may be used to determine the nature and/or properties of a real device which is not self-aware (i.e. a real device that does not know what it is and may be referred to as an ‘unknown data source’) when it switches on for the very first time. In such an application, the method of FIG. 1 enables attributes and properties of a real device to be determined and specified remotely from the real device, thereby providing a device which can be flexibly deployed (since its attributes and properties are determined after manufacture and after deployment). In an example, the real device may be a sensor (e.g. a water flow sensor) which may be deployed in many different environments and locations (e.g. in a washing machine, in a central heating system, in an industrial environment such as a factory or a power plant). It is not necessary to pre-configure the real device but its location/application can be inferred using the method of FIG. 1 after deployment.

The method of FIG. 1 may be used to identify either what the real device is (e.g. it is a water level sensor) or what the data stream represents (e.g. the data provides tidal information). In another example, the data stream may be electricity usage and the real device may be one of many different electrical appliances. In an example, the data received from an unknown data source may include sensor data values, time stamps and location information. The asset that implements the method of FIG. 1, receives the data stream either directly from the data source or via another virtual asset (in block 102), extracts the location information, which is a characteristic of the data (in block 202) and identifies a candidate set of data streams based on that location e.g. data streams from proximate data sources, data streams from data streams in similar types of locations, etc. (in block 202 or 216). The data streams in the candidate set of data streams may originate from classified data sources, i.e. data sources for which a class ID is already known. The asset then compares characteristics of the data received from the data source (aside from the location data) to the candidate data streams (in block 216) and based on any similarities or matches, determines some contextual metadata for the data source (in block 218). As described above, the contextual metadata that is determined may comprise a portion of the metadata for a data stream that is found to be the closest match or may be derived from the metadata for a data stream that is found to be the closest match. This contextual metadata may include a class ID or be used to identify a class ID (in block 206). As described above, this class ID is then added to the registry entry for the virtual asset which is the counterpart to the real device (in block 108). As before, if the real device is subsequently redeployed the method of FIG. 1 may be repeated to update/overwrite the class ID stored in the registry entry of the counterpart virtual asset.

In examples where the real device is self-aware or has previously been classified (e.g. using the method of FIG. 1), the method FIG. 1 may be used to enrich the information that is stored about the real device, by adding an additional class ID. For example, a water level sensor may already have a class ID stored that identifies that it is a water level sensor; however, analysis of its data stream (in block 202) may determine based on location data in the data stream and comparison with data streams from proximate data sources, that the water level sensor is a river level sensor or a tidal sensor and additional class IDs may be added to the registry entry (in block 108) to indicate this.

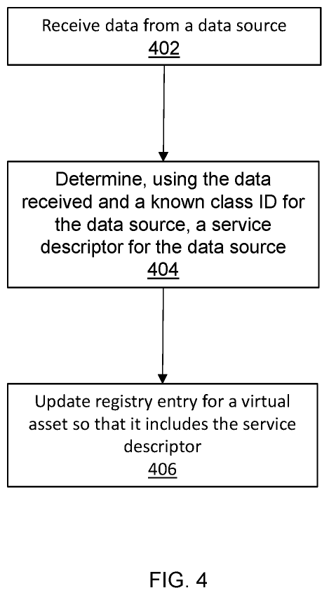

Having determined a class ID (in block 104) this may be used to determine other attributes of the data source, e.g. one or more service descriptors (block 106) and then, in addition to updating the registry entry to include the class ID, the registry entry may also be updated to include such attributes, e.g. the one or more service descriptors associated with the determined class ID (block 110). For example, if the determined class ID is for a light sensor, the associated service descriptor may advertise the ability to share a data stream of light levels. There may be a fixed relationship between a class ID and its associated service descriptors and/or the service descriptors may be determined based on the contextual metadata (determined in block 202), e.g. based on the service descriptors of a matching data source. A method of dynamically determining device functionality, and hence service descriptors (in block 106) is described below with reference to FIGS. 4-6.

In the examples described above, the method of FIG. 1 is implemented by an agent corresponding to a single virtual asset. In other examples, however, it may be performed independently by agents corresponding to several different virtual assets in relation to the same candidate data source (i.e. the data source being classified). In such an example, each of the virtual assets may exchange their determined class ID (after the determination by their corresponding agent using the method of FIG. 1, but before the registry entry has been updated) and the registry entry may then be updated by one of the agents (e.g. the agent corresponding to the virtual asset whose registry entry is being updated) based on a consensus (in block 108) or based on all the determined class IDs (e.g. more than one class ID may be added where there is not agreement between the class IDs determined by each of the virtual assets).

In some examples, the determination of a class ID may be accompanied by an associated confidence value, i.e. a value that indicates the likelihood that the determined class ID is correct, and this confidence value may be determined as part of the comparison (e.g. matching) process.

In some examples, when a class ID is determined, the classified data source may be assigned to a community of data sources. Over time, the registry or a virtual asset in the connection brokerage system may analyse the data streams of the data sources in the community to identify any that diverge as this may indicate that either the data source was incorrectly classified or that the data source has been moved or repurposed. Where a confidence level is defined for a class ID, the analysis of the community may result in changes to the confidence level, either an increase in confidence level (e.g. where a data source continues to generate data signatures that match others in the community) or a decrease (e.g. where its data signature deviates from the rest of the community). Where a mismatch is detected, or the confidence level (if used) falls below a threshold, the method of FIG. 1 may be repeated to reclassify the data source.

Another way that may be used to validate a determination of a class ID and/or update an associated confidence level may be through sending a test actuation command to the data source, or to the matching data source. Referring back to the garden sprinkler-water sensor example, having determined, using the method of FIG. 1, that there is a complementary match between the unclassified water sensor and the known garden sprinkler, a class ID of ‘water sensor’ may be determined. To test this, an actuation command may be sent to the garden sprinkler and the data stream monitored for a corresponding response.

In the methods described above, the class ID that is determined (in block 104) relates to a single real data source. In some examples, the data source may be a virtual asset that generates a data stream based on data received from a group of real data sources via their corresponding virtual assets. In such an example, the class ID that is determined and added to the registry entry of the “virtual” data source may relate to the collective identity of the group of data sources.

As described above, the registry entry stores attributes and properties of a virtual asset. The attributes may include the class ID and the properties may include one or more service descriptors. These service descriptors may, for example, define feeds that the service providing virtual asset can provide to a service requesting virtual asset that has subscribed and/or define controls that the service providing virtual asset can receive from a service requesting virtual asset that has subscribed. The service descriptors may be solely on the class ID of the virtual asset, such that there is a 1:1 relationship between class ID and service descriptors; however, as there may be devices that can be deployed in very different situations and as a result offer different services (in terms of data feeds or control inputs), then this may result in a proliferation of class IDs that reduces the scalability of the system.

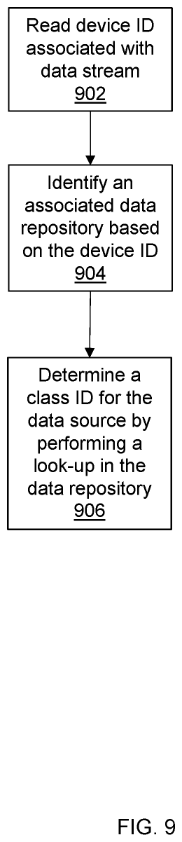

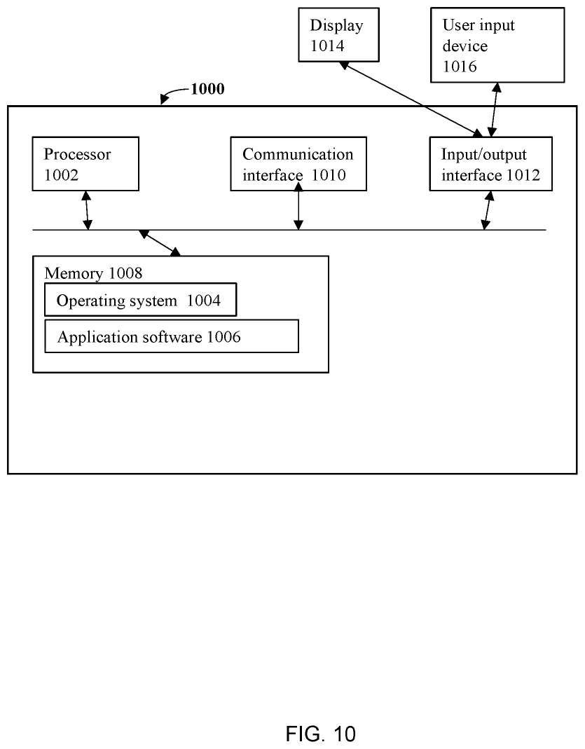

In addition, or instead, service descriptors may be dynamically determined based on the data received from a service providing virtual asset and then the determined service descriptor may be applied to the virtual asset by updating the registry entry. This determination may use an already known class ID when determining the service descriptor; however, by using the data, a much richer set of service descriptors are enabled. The class ID may have been determined using the method of FIG. 1 (as described above), it may have been based on an identifier of the data source (as described below with reference to FIG. 9) or by any other method.

In an example, the data source may be a water flow sensor and the class ID stored in the registry entry of its counterpart virtual asset may be the class ID for water flow sensors. There may be one or more pre-defined service descriptors that are included in the properties of the registry entry for the counterpart virtual asset as a direct consequence of its classification, e.g. a service descriptor indicating that the virtual asset can share a data stream of water flow data. The water flow sensor may be deployed in many different systems and situations and in an example, the water flow sensor may be deployed in a central heating system. There may be a separate class ID for water flow sensors in central heating systems and instead of configuring this on deployment of the sensor, this additional service descriptor may instead be determined using the method of FIG. 1 as described below. By using the method of FIG. 1, the service descriptor may be determined in a less complex manner (e.g. more quickly and/or using less processing resources) and as the service descriptor is not limited by the available class IDs, there is an ability to provide much richer (e.g. more descriptive, varied and/or nuanced) service descriptors.

FIG. 4 shows a flow diagram of an example method of dynamically assigning functionality to a virtual asset that is either a data source (e.g. where the virtual asset is not a real device but generates a data stream from other data received by the virtual asset) or is the virtual counterpart of a real device that is a data source. This method may be implemented in a connection brokerage system as described above. The method comprises receiving data from a data source (block 402), where the data source has previously been classified and hence has a known class ID (e.g. stored in its registry entry, where the data source is a virtual asset, or stored in the registry entry of its counterpart virtual asset where the data source is a real device). The data source from which data is received (in block 402) may be a real (physical) device, for example, be an object, a sensor, a machine part, and actuatable machine part or a device. As noted above, the data source may alternatively be a virtual asset.

Having received the data (in block 402), this data, along with the class ID for the data source, is then used to determine a service descriptor for the data source itself (where it is a virtual asset) or its counterpart virtual asset where the data source is a real device (block 404). The registry entry for a virtual asset is then updated to include the determined service descriptor (block 406). Where the data source is a real device, the registry entry that is updated (in block 406) may be the registry entry for a counterpart virtual asset or a registry entry of a newly created virtual asset (e.g. a shadow virtual asset, as described above). Where the data source is a virtual asset, the registry entry that is updated (in block 406) may be the registry entry of the data source or a registry entry of a newly created virtual asset. As a consequence of the update to the registry entry (in block 406), new connections may be brokered with the virtual asset based on the determined service descriptor (e.g. as a result of a service requesting virtual asset looking for a service providing virtual asset with the determined service descriptor).

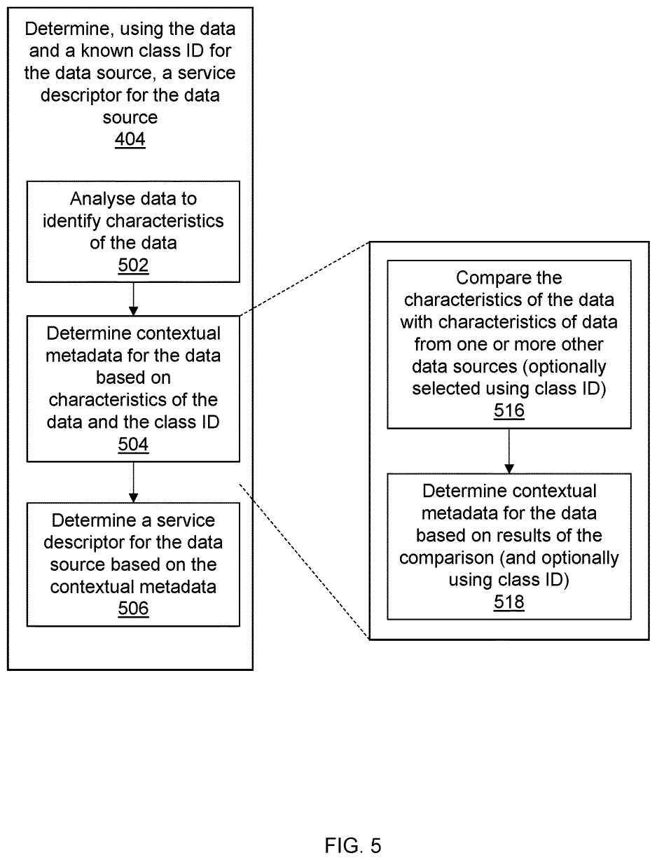

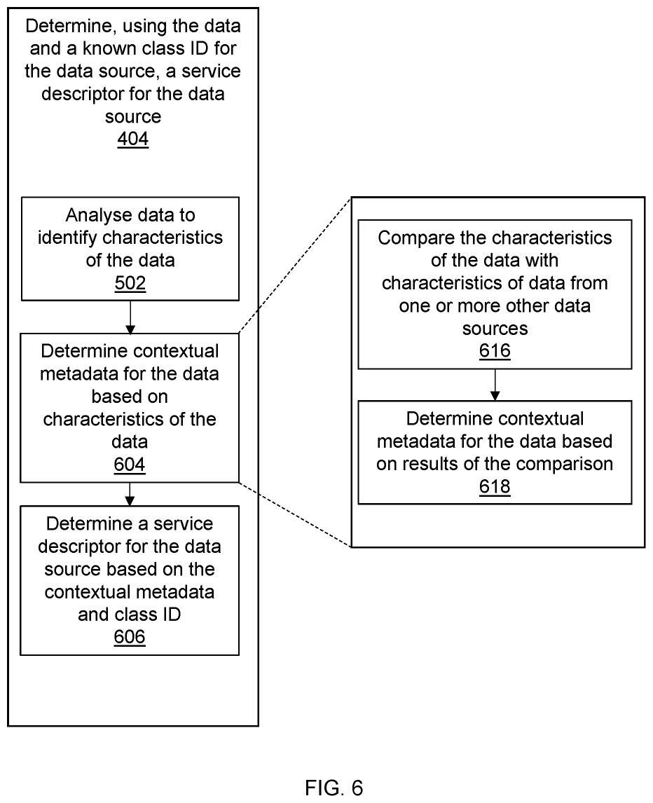

There are a number of different ways in which the service descriptor can be determined using both the class ID and the data (in block 404) and two examples are shown in FIGS. 5 and 6. Both examples involve analysing the data to identify characteristics of the data (block 502) and both involve use of data from one or more other data sources in order to determine the service descriptor. In the example shown in FIG. 5, both the class ID and the characteristics of the data are used to determine contextual metadata (block 504) and then the contextual metadata is used to determine a service descriptor (block 506). In example shown in FIG. 6, however, the characteristics of the data, without the class ID, are used to determine the contextual metadata (block 604) and then the contextual metadata and the class ID are both used to determine a service descriptor (block 606). In yet further examples, the class ID may be used both in determining the contextual metadata and in determining the service descriptor from the contextual metadata, or the class ID, without the data, may be used to determine the contextual metadata and then the contextual metadata and the data may together be used to determine the service descriptor.

The characteristics of the data that are identified (in block 202) may comprise one or more of: the location of the data source (e.g. if included in the data), the data values or ranges of the data values (e.g. values are always in a range 0-100° C.), the format of the digital data and the data time signature (e.g. the times when data is generated or the times when there are changes in the data such as a step change in data value or a data value crossing a threshold). The data time signature may define one or more patterns in the data.

The analysis (in block 502) may comprise temporal analysis of the data and/or identification of trends in the sensor data values. For example, the times when particular events occur, or the periodicity of events, may be used to determine contextual metadata (in block 504). For example, such analysis (in block 502) may identify that the data peaks twice a day, approximately 12.5 hours apart, such that the peaks shift gradually later each day. Where the data (as received in block 402) includes the type and/or location of the data source, then the analysis of the data to identify characteristics of the data (in block 502) may comprise extracting the locations and/or type. In addition or instead, the analysis (in block 502) may identify an data time signature (e.g. a sequence or pattern of event times) from the data stream.

In the method of FIG. 5, having identified characteristics of the data (in block 502), the contextual metadata is determined based on these characteristics and the class ID (block 504). The resulting contextual metadata is then used to determine the service descriptor (block 506).

The determination of the contextual metadata based on the characteristics (in block 504) may involve a comparison with data from one or more other data sources (block 516). The comparison (in block 516) may involve comparing data signatures to look for correlations between data, e.g. to identify one or more known data sources with the same or similar characteristics, where the term ‘known data source’ is used to refer to a data source which has already been classified and hence already has a class ID stored in its registry entry. The comparison may, for example, identify data sources with matching data time signatures (i.e. where events of the same nature/type happen at approximately the same time), data sources with matching but offset data time signatures (e.g. where the pattern or periodicity of data time signatures is substantially the same but the actual event times are time shifted, for example by substantially the same amount for each event), data sources with similar data time signatures (e.g. where the pattern or periodicity of data time signatures is substantially the same but the amplitudes of the signals are larger or smaller), data sources with complementary data time signatures (e.g. where the events happen at substantially the same time but the nature/type of the event/change is different), or any combination thereof.

In a first example, the analysis (in block 502) may identify an data time signature (e.g. a sequence or pattern of event times) from the data stream. This data time signature may define that the data goes from low to high at times X1, X2, X3, . . . Then the comparison (in block 516) may identify a known data source where the data time signature comprises the same sequence of events at the same time intervals, but that the pattern of events for the two data sources (the data source that is being analysed and may be referred to as the ‘unknown’ data source and the known data source) but the two patterns start at times which are offset, i.e. the data time signature of the known data source may define that the data goes from low to high at times X1+A, X2+A, X3+A,

In a second example, the analysis (in block 502) may identify an data time signature (e.g. a sequence or pattern of event times) from the data stream. This data time signature may define that the data goes from low to high at times X1, X2, X3, . . . Then the comparison (in block 516) may identify a known data source where the data time signature comprises the same sequence of event times, but the events correspond to the data going from high to low, i.e. the data time signature of the known data source may define that the data goes from high to low at times X1+A, X2+A, X3+A, . . . (where A may be zero or may be non-zero). This may be referred to as an ‘inverse correlation’and is an example of a ‘complementary match’.

It will be appreciated that the comparison of data streams (in block 516) may involve more complex techniques for pattern matching of data signatures which are based on both the time sequence of the events in the data stream and the nature of those events. In various examples, a candidate set of comparison data streams may be identified based on one or more characteristics (as identified in block 502), such as the type or location of the data source and then the comparison may be performed (in block 516) between the data for the data source and the data for the comparison data streams.

In the examples described above a pairwise comparison may be performed between data time signatures for different data sources. In other examples, a candidate data time signature (i.e. the data time signature from the data source which is being classified) may be compared to aggregated data time signatures from a number of data sources, e.g. a cohort of data sources, such as all river level sensors on a particular river or all light level sensors in a particular geographic location, etc.

The streams of data that are used for the comparison (in block 516) may be selected based on the known class ID of the data source from which data has been received (in block 402). The identification of the set of candidate data stream for use in the comparison (in block 516) may comprise querying registry entries for virtual assets to identify data sources with a particular class ID. For example, data streams with the same or related class IDs may be used. In addition (or instead) data streams from data sources with complementary class IDs may be used. An example of a complementary class ID is a class ID for a sensor and a class ID for an actuator that can trigger the sensor. Another example is class IDs for different types of sensor which detect the same or related phenomenon.

Having performed the comparison (in block 516), contextual metadata is determined based on the results of the comparison (block 518). For example, where an exact match is identified, the contextual metadata may be determined to be the same as the metadata of the matching known data source (e.g. it may comprise one or more service descriptors associated with the matching known data source) and/or identify the matching known data source. Where a time-shifted match is identified, the contextual metadata may be determined to be the same as the metadata of the matching known data source (e.g. it may comprise one or more service descriptors associated with the matching known data source) and/or identify the matching known data source, although in some examples there may be additional metadata included to identify the time offset. Where a complementary match is identified, the contextual metadata may include some of the metadata of the complementary known data source (e.g. it may comprise one or more service descriptors associated with the matching known data source) and/or identify the matching known data source, with additional metadata to indicate the identified complementary nature of the relationship between the two data sources.

In the method shown in FIG. 5, the service descriptor is determined based on the contextual metadata (in block 506). This determination may involve extracting a service descriptor from the contextual metadata and determining, based on the nature of the comparison result (as detailed in the contextual metadata) whether to select the same service descriptor or a different service descriptor (e.g. a service descriptor derived based on the service descriptor of the known data source and the nature of the comparison result). Where the contextual metadata does not comprise a service descriptor, but instead comprises data identifying a known data source and the nature of the match, the determination of the service descriptor (in block 206) may be determined based on this data and may, for example, involve looking up the service descriptor of the known data source using the contextual metadata.

Where the method of FIG. 6 is used, the contextual metadata is determined (in block 604) in a similar manner to that described above with reference to FIG. 5, but without reference to the class ID (in either of blocks 616 and 618) and then the service descriptor is determined (in block 606) based on both the contextual metadata and the class ID.

The determination of the service descriptor (in block 606) may involve extracting one or more service descriptors from the contextual metadata and determining, based on the nature of the comparison result (as detailed in the contextual metadata) and the class ID whether to select the same service descriptor or a different service descriptor (e.g. a service descriptor derived based on the service descriptor of the known data source, the class ID and the nature of the comparison result). Where the contextual metadata does not comprise a service descriptor, but instead comprises data identifying a known data source and the nature of the match, the determination of the service descriptor (in block 606) may involve looking up the service descriptor of the known data source using the contextual metadata and then determining based on the class ID and the nature of the comparison whether to select the same service descriptor or a different service descriptor (e.g. a service descriptor derived based on the service descriptor of the known data source, the class ID and the nature of the comparison result).

Four example scenarios for the implementation of the method of FIG. 4 can be described with reference to FIGS. 3A-3D. In all these examples, the data source 302 is a real device that generates the data, but as described above, the data source may alternatively be a virtual asset.

In the example shown in FIG. 3A the data is received by the real device's counterpart virtual asset 304 via its agent 305. A second virtual asset 306 which has already brokered a connection with the first virtual asset 304 receives the data stream. This second virtual asset 306 may have a counterpart real device 308. The agent 307 of the second virtual asset 306, or its counterpart real device 308, implements the method of FIG. 4 and identifies a service descriptor. In this example, the second virtual asset 306 has subscribed not only to receive the data stream but also to a “receive control in” service of the first virtual asset 302, and so the updating step of the method of FIG. 4 (block 406) comprises the agent 307 of the second virtual asset 306 providing the service descriptor to the first virtual asset 304 to trigger the agent 305 of the first virtual asset 304 to update the registry entry of the first virtual asset 304.

In the example shown in FIG. 3B the second virtual asset 306 (and, where there is one, its counterpart real device 308) belong to the owner (e.g. manufacturer) of the data source 302, so that the two virtual assets 304, 306 are related. This relationship between the first and second virtual assets 304, 306 means that the agent 307 of the second virtual asset 306 has the ability to update the registry entry for the first virtual asset 304, i.e. agent 307 has delegation of control for the first virtual asset 304 and this delegation may be permanent or temporary, as described above. The data is received from the data source 302 by its counterpart virtual asset 304 via its agent 305. A second virtual asset 306 which has already brokered a connection with the first virtual asset receives the data stream. The agent 307 of the second virtual asset 306, or its counterpart real device 308, implements the method of FIG. 4 and identifies a service descriptor. In this example, the updating step of the method of FIG. 4 (block 406) comprises the agent 307 of the second virtual asset 306 updating the registry entry of the first virtual asset to include the determined service descriptor.

In the example shown in FIG. 3C the method of FIG. 4 is implemented by the agent 305 of the counterpart virtual asset 304, rather than by the agent of another virtual or by a real device in the system. The data from the data source 302 is received by its counterpart virtual asset 304 via its agent. The agent 305 of the counterpart virtual asset 304 implements the method of FIG. 4 and identifies a service descriptor and updates its own registry entry to store the service descriptor.

In the example shown in FIG. 3D either the first virtual asset does not advertise a ‘control in’ that enables the second virtual asset to provide the service descriptor to the first virtual asset or the second virtual asset has not brokered the required connection to be able to provide that data to the first virtual asset. As before, the data is received from the data source 302 by its counterpart virtual asset 304 via its agent 305. A second virtual asset 306 which has already brokered a connection with the first virtual asset receives the data stream. The agent 307 of the second virtual asset 306, or its counterpart real device 308, implements the method of FIG. 4 and identifies a service descriptor. In this example, the updating step of the method of FIG. 4 comprises the creation of a new registry entry including the determined service descriptor and hence the creation of a new virtual asset 410 and the forwarding of the received data stream from the second virtual asset 306 to the newly created virtual asset 410. In the example shown, the agent 307 of the second virtual asset 306 is also the agent for the newly created virtual asset 310; however in another example the agent 307 may create a new agent for the newly created virtual asset 310 and then cancel its delegation of control of the newly created virtual asset 310, such that the newly created virtual asset 310 subsequently operates independently of the agent 307 of the second virtual asset 306. Having been created, the newly created virtual asset 310 may then broker a connection with the first virtual asset so that it can obtain the data stream directly from the first virtual asset 306 and/or provide control data to the first virtual asset 306, rather than the data stream or control data passing via the second virtual asset 306. The newly created virtual asset 310 will be identified in different searches by the registrar function when brokering connections as a consequence of the different service descriptor.

As described above, the method of FIG. 4 may be used to dynamically assign functionality to a virtual asset. This enables functionality to be dynamically assigned where this functionality is a consequence of the deployment of the corresponding real device rather than simply a consequence of the inherent properties of the real device. This simplifies the deployment process (e.g. because functionality can be dynamically assigned after deployment rather than needing to be done at the time) and enables flexible deployment (e.g. the same type of real device may be deployed in many different locations and subsequently assigned different functionality as a consequence of these different locations, despite all of the real devices belonging to the same class). The method may enable “fluid” deployment, such that a real device is deployed in a first location (e.g. by being dropped into a river, pipe or cave system) without its ultimate destination being known. Its functionality may be updated over time using the methods described above to respond to changes in location of the real device. The method also provides a means to update and enhance functionality provided by virtual assets within a connection brokerage system over time (e.g. a virtual asset which is the virtual counterpart of a light level sensor may have an initial service descriptor that indicates that it can provide a data stream of light level data; however, where the real device is deployed in a warehouse with motion triggered lighting, the method of FIG. 4 may be used to determine and add a service descriptor indicating that the corresponding virtual asset can provide a data stream indicating the presence of people). This may, for example, enable reuse and repurposing of real devices.

In an example, the data source may be a water level sensor and the class ID stored in the registry entry of its counterpart virtual asset may be the class ID for water level sensors. As a result of this, the counterpart virtual asset may already have a service descriptor indicating that it can share a data stream of water level data. The location of deployment of the water level sensor may not be known (e.g. because it does not comprise any GPS capability). Using the upper example method in FIG. 4, the characteristics of the data (e.g. maximum and minimum water levels and their corresponding timestamps) may be compared to data streams from other water level sensors (in block 516) and one or more other water level sensors with very similar data patterns may be identified. Contextual metadata may then be determined (in block 518) based on the results of the comparison, e.g. based on the contextual metadata of each of the water level sensors with very similar data patterns. This contextual metadata may, for example, comprise the locations of those matching water level sensors. Using this contextual metadata, the location of the particular water level sensor (with the unknown location) may be inferred. For example, if all the matching water level sensors are located along the River Severn, then it may be determined (in block 506 or 518) that the water level sensor is also located along the River Severn and a service descriptor may be determined that indicates that the corresponding virtual asset can share a data stream of water level of the River Severn. This service descriptor provides a richer description of the data than the original service descriptor associated with the data source's class ID. Furthermore, by analysing the differences between the data patterns of each of the matching water level sensor and the data patterns of the received data, then the position of the water level sensor may be more accurately determined and hence can be defined in the service descriptor. In addition, or alternatively, if the location of the water level sensor is determined to be in a part of the River Severn which experiences the Severn Bore (e.g. based on a comparison of the data to a known occurrence of the Severn Bore or based on whether the matching water level sensors have such a service descriptor), a service descriptor may be determined that indicates that the corresponding virtual asset can share a data stream of measurements of the Severn Bore.

In another example, a large number of temperature sensors may be deployed across a manufacturing facility. Some may be deployed on particular pieces of equipment and by correlating the detected temperatures (i.e. characteristics of the event streams from the sensors) with other data streams, such as those showing when particular pieces of equipment are operating, the method of FIG. 4 may be used to add service descriptors which indicate when a particular piece of equipment is operating, when a particular piece of equipment has malfunctioned (e.g. is overheating), etc. This enables collection of a huge and rich amount of operational monitoring data from the manufacturing facility but reduces the cost and time taken to deploy the sensors (e.g. because it is not necessary to program, at the outset, the location of each sensor) and provides a mechanism to upgrade the operational monitoring data over time (e.g. by analysing data using the method of FIG. 4 and adding new service descriptors). Furthermore, the arrangement of real devices can be reconfigured at any time without needing to re-do the commissioning, but instead new service descriptors can be added. The method of FIG. 4 may also be used to remove incorrect or out-of-date service descriptors, e.g. where part of the functionality of the real device has failed (e.g. a local sensor or actuator), to enable a real device to continue to work with its remaining capabilities.

In all the above examples described above, the service descriptor that is determined using the method of FIG. 4, relates to provision of a data stream. As described above, where a virtual asset is the counterpart of a real device which can be remotely actuated (e.g. a remotely actuated switch, valve, motor or other device), the method of FIG. 4 may be used to dynamically assign control functionality to a virtual device. For example, the stream from the data source that is received (in block 402) may comprise a series of data events indicating the state of the actuatable real device along with timestamps or may comprise a series of control commands sent to the actuatable real device. Characteristics of this stream may be compared (in blocks 516 and 616) with characteristics of data from data sources that are sensors and based on this analysis a service descriptor may be determined (e.g. defined) that more accurately defines the control functionality that is advertised by the virtual asset. For example, in addition to a service descriptor that indicates that controls can be received to open or close a valve, a service descriptor may be added that indicates that controls can be received to remotely empty a tank (e.g. where the data is correlated with a water level sensor in the tank) or remotely turn a radiator on and off (e.g. where the data is correlated with a temperature sensor on or close to the radiator).

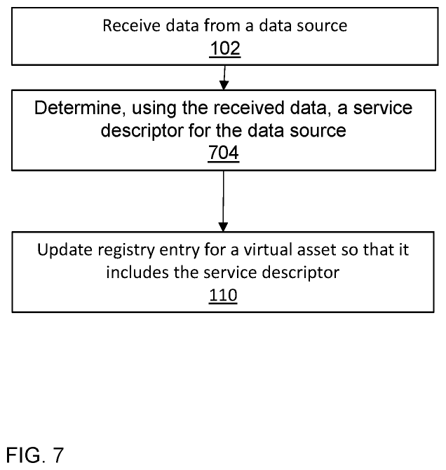

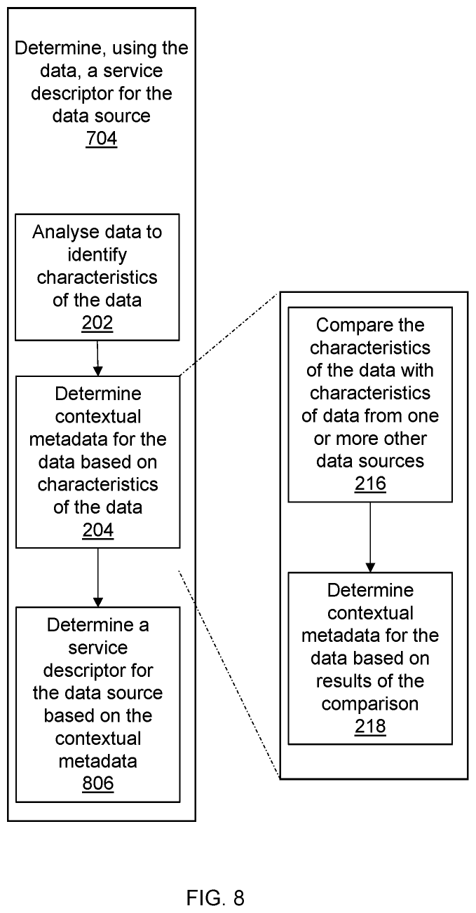

Whilst the method described above and shown in FIG. 1 refers to the determination of a class ID (in block 104) and then, optionally, generation of a service descriptor using the class ID (e.g. using the method of FIG. 4 or another method), in other examples method of FIG. 4 may be implemented independently of the method of FIG. 1. In yet further examples, the determination of the service descriptor may be performed without first determining the class ID. In such an example, the techniques described above to determine the class ID (e.g. in relation to block 104) may be used in an analogous manner to determine a service descriptor directly (in block 704), without first determining a class ID, as shown in FIGS. 7 and 8. As shown in FIG. 8, the determination of the service descriptor (in block 704) uses the same method as described above with reference to FIG. 2, except that it is the service descriptor that is determined based on the contextual metadata (in block 806), rather than the class ID.

This determination (in block 806) may involve extracting the service descriptor from the contextual metadata and determining, based on the nature of the comparison result (as detailed in the contextual metadata) whether to select the same service descriptor or a different service descriptor (e.g. a service descriptor derived based on the service descriptor of the known data source and the nature of the comparison result). Referring back to the water sensor—garden sprinkler example, if the known data source is the water sensor and the match is determined to be complementary, the unknown data source may be given a service descriptor corresponding to a water source. Where the contextual metadata does not comprise a service descriptor, but instead comprises data identifying a known data source and the nature of the match, the determination of the service descriptor (in block 806) may be determined based on this data and may, for example, involve looking up the service descriptor of the known data source using the contextual metadata.

In the methods described above, the service descriptor is determined based on a single class ID for the data source. In some examples, the data source may be a complex system or function (e.g. comprising more than one data source and their corresponding virtual assets) and as a result the data source may have more than one class ID. Where the data source has more than one class ID, the methods described above may be implemented using some or all of the class IDs of the data source.

As described above, the method of FIG. 4 may be used in combination with the method of FIG. 1 (to determine the class ID) or the class ID may be determined in any other way. FIG. 9 shows an example of another method of determining the class ID. In this example, an identifier of real device that generates the data stream is read (block 902). This device ID may be part of the data stream or otherwise associated with the data stream (e.g. stored in metadata relating to the data stream) and may be the serial number of the device or other manufacturer assigned identifier. A data repository associated with the device ID is then identified (block 904). A data repository may be identified directly from the device ID or an owner of the data source may be identifiable from the device ID and then a data repository identified based on the owner information. The owner may, for example, be the manufacturer of the real device that is the data source or may be the organisation (e.g. corporation) that deployed the real device that is the data source. In such an example, the class ID is then determined (in block 906) by performing a look-up of the class ID directly in the data repository using the device ID or by performing a look-up in the data repository for data from which the class ID can be derived.

As described above, the agents of the virtual assets may run on a computing device, with a single computing device running one or more agents. The term ‘computing device’ and ‘computer’ is used herein to refer to any device with processing capability such that it can execute instructions. Those skilled in the art will realize that such processing capabilities are incorporated into many different devices and therefore the term ‘computer’ includes PCS, servers, mobile telephones, personal digital assistants and many other devices. FIG. 10 shows an example computing device 1000.

Computing device 1000 comprises one or more processors 1002 which may be microprocessors, controllers or any other suitable type of processors for processing computer executable instructions to control the operation of the device in order to implement the methods described herein (e.g. to execute a virtual agent). In some examples, for example where a system on a chip architecture is used, the processors 1002 may include one or more fixed function blocks (also referred to as accelerators) which implement a part of the method of a virtual agent in hardware (rather than software or firmware). Platform software comprising an operating system 1004 or any other suitable platform software may be provided at the computing-based device to enable application software 1006 to be executed on the device.

The computer executable instructions may be provided using any computer-readable media that is accessible by computing device 1000. Computer-readable media may include, for example, computer storage media such as memory 1008 and communications media. Computer storage media, such as memory 1008, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 1008) is shown within the computing device 1008 it will be appreciated that the storage may be distributed or located remotely and accessed via a network or other communication link (e.g. using communication interface 1010).

The computing device 1000 also comprises an input/output interface 1012 arranged to output display information to a display device 1014 which may be separate from or integral to the computing device 1000. The display information may provide a graphical user interface. The input/output interface 1012 is also arranged to receive and process input from one or more devices, such as a user input device 1016 (e.g. a mouse or a keyboard). This user input may be used to provide user input to a virtual agent, send trigger signals, etc. In an embodiment the display device 1014 may also act as the user input device 1016 if it is a touch sensitive display device. The input/output interface 1012 may also output data to devices other than the display device, e.g. a locally connected printing device (not shown in FIG. 10).

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of dynamically classifying a data source in a connection brokerage system, the method comprising:
receiving data from the data source
determining, based on the data, a class identifier, ID, for the data source wherein the class ID defines what the data source is and/or what the data from the data source represents; and
updating a registry entry for a virtual asset registered in the connection brokerage system to store the determined class ID for the data source

2. The method according to claim 1, wherein the class ID identifies a type of device corresponding to the data source or a type of a data stream generated by the data source.

3. The method according to claim 1, wherein the data received from the data source is time series data.

4. The method according to claim 1, wherein determining, based on the data, a class ID for the data source comprises:
determining, based on one or more determined characteristics of the data, contextual metadata for the received data;
determining, based on the determined contextual metadata, a class ID for the data source (206).

5. The method according to claim 4, wherein the one or more determined characteristics of the data comprise one or more of: a location of the data source, data values in the data, ranges of the data values, a format of the data and the data time signature.

6. The method according to claim 1, wherein the contextual metadata is determined by analysing digital data in the digital message stream and digital data in at least one other digital message stream received from a different data source.

7. The method according to claim 6, wherein analysing digital data in the digital message stream and digital data in at least one other digital message stream received from a different data source comprises:
identifying patterns in the digital data streams and looking for correlations between patterns in different digital data streams.

8. The method according to claim wherein determining, based on one or more determined characteristics of the data, contextual metadata for the received data comprises:
determining characteristics of the data;
comparing the characteristics of the data with characteristics of data from one or more other data sources; and
determining contextual metadata for the data based on results of the comparison.

9. The method according to claim 8, wherein determining, based on the determined contextual metadata, a class ID for the data source comprises:
setting the class ID of the unknown data source to match a class ID of the classified known data source with matching characteristics.

10. The method according to claim 1, further comprising:
determining one or more service descriptors based on the class ID and
updating the registry entry with the determined service descriptors

11. The method according to claim 1, wherein the data source from which the data is received is an unknown data source.

12. The method according to claim 1, wherein data is a digital message stream and wherein the contextual metadata is determined by analysing digital data in the digital message stream.

13. The method according to claim 12, wherein analysing digital data in the digital message stream comprises analysing values and/or format of the digital data. comprises identifying one or more patterns in the values of the digital data.

15. A system comprising a connection brokerage system, a computing device external to the connection brokerage system, and at least one agent running on the computing device external to the connection brokerage system and associated with a virtual asset in the connection brokerage system, wherein the at least one agent is configured to:
receive data from the data source;
determine, based on the data, a class identifier, ID, for the data source, wherein the class ID defines what the data source is and/or what the data from the data source represents; and
update a registry entry for a virtual asset registered in the connection brokerage system to store the determined class ID for the data source.

16. A system comprising a connection brokerage system and a device external to the connection brokerage system, wherein the device is a real device associated with a virtual asset in the connection brokerage system, wherein the device is configured to:
receive data from the data source;
determine, based on the data, a class identifier, ID, for the data source, wherein the class ID defines what the data source is and/or what the data from the data source represents; and
update a registry entry for a virtual asset registered in the connection brokerage system to store the determined class ID for the data source.

17. (canceled)

18. A non-transitory, computer readable medium arranged to store computer readable code, wherein the code, when executed by a computing device, causes the computing device to perform steps comprising:
receiving data from the data source;
determining, based on the data, a class identifier, ID, for the data source, wherein the class ID defines what the data source is and/or what the data from the data source represents; and
updating a registry entry for a virtual asset registered in the connection brokerage system to store the determined class ID for the data source.
